(19) United States
(12) Patent Application Publication
(10) Pub. No.: US 2004/0190569 A1
(43) Pub. Date: Sep. 30, 2004

(54) Apparatus for compensating for characteristics of laser diode and optical transmitter including the apparatus

(76) Inventors: Ho Yong Kang, Daejeon-city (KR); Hyun Kyun Choi, Daejeon-city (KR); Yong Hun Oh, Daejeon-city (KR); Tae Whan Yoo, Daejeon-city (KR); Hyeong Ho Lee, Daejeon-city (KR); Sang Gug Lee, Daejeon-city (KR); Man Seop Lee, Daejeon-city (KR); Quan Le, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/810,202

(22) Filed: Mar. 26, 2004

(30) Foreign Application Priority Data
Mar. 29, 2003 (KR) 2003-19823

(51) Int. Cl. H01S 3/13; H01S 3/00

(52) U.S. Cl. 372/29.021

(57) ABSTRACT

Provided are an apparatus for compensating for the characteristics of a laser diode and an optical transmitter including the apparatus. The apparatus includes: an optical output detector which detects an optical power output from the laser diode and converts the optical power into a voltage; a bias current controller which detects a maximum level of the voltage and outputs a first control value corresponding to a difference between the maximum level and a first reference voltage; a modulation current controller which detects a minimum level of the voltage and outputs a second control value corresponding to a difference between the minimum level and a second reference voltage; and a laser diode driver which outputs a drive current to the laser diode according to the first and second control values.

### BACKGROUND OF THE INVENTION

This application claims the priority of Korean Patent Application No. 2003-19823, filed on Mar. 29, 2003, in the Korean Intellectual Property Office, the disclosure of which is incorporated herein in its entirety by reference.

1. Field of the Invention

The present invention relates to an apparatus for compensating for characteristics of a laser diode and an optical transmitter including the apparatus, and more particularly, to an apparatus for compensating for characteristics of a laser diode varying depending on variations in a temperature and an optical transmitter including the apparatus.

2. Description of the Related Art

In general, on the characteristic curve of a semiconductor laser diode (LD), as an ambient temperature increases, a threshold current Iₜₕ increases and an inclination η, namely slope efficiency, of a current-optical output curve decreases.

FIGS. 2A and 2B show such characteristics of an LD. FIG. 2A shows a lower temperature characteristic compared to a temperature characteristics of FIG. 2B. Reference numerals 20-1 and 20-2 denote average powers of the LD, respectively, reference numerals 21-1 and 21-2 denote amplitudes of output optical pulses, and reference numerals 22-1 and 22-2 denote threshold currents at T₁ and T₂, respectively. Reference numerals 23 and 24 denote a bias current signal and a modulation current signal input to the LD, respectively.

Referring to FIGS. 2A and 2B, as the temperature increases, the inclination of the curve decreases. Subsequently, an optical power level decreases, and an extinction ratio P₁/P₀, which is defined as an optical power ratio corresponding to digital levels “1” to “0”, decreases. Accordingly, as the temperature increases, transmission efficiency is lowered. In a case of a transmission module used for an optical communication, an extinction ratio is recommended according to the specification of the International Telecommunication Union (ITU). Thus, the extinction ratio may not satisfy the ITU specification in a predetermined temperature range due to the temperature characteristic of a semiconductor LD. Also, output powers P₁ and P₀ of the LD corresponding to the levels “1” and “0” need to be constant regardless of variations in the temperature so that an optical receiver easily performs a signal reception operation. Therefore, a bias current and a modulation current of a semiconductor LD need to be controlled to provide a constant extinction ratio and optical output power regardless of variations in the temperature.

In the prior art, an apparatus as shown in FIG. 3 is adopted to control a bias current and a modulation current. Referring to FIG. 3, when an LD outputs an optical signal, a photo-detector (PD) detects the optical signal and converts the optical signal into an electric signal. A bias current controller 30 detects a difference between peak levels via positive and negative peak sensors D₁ and D₂, compares the difference with a first reference voltage V_{ref1} transferred via a resistance R₁ at level “1”, and controls a bias current of the LD. A modulation current controller 31 compares a second reference voltage V_{ref2} transferred via a resistance R₂, which sets an average optical output, with an output of the PD and controls a modulation current.

However, in a method of controlling a bias current of an LD using an average optical output value, if the inclination of the characteristic curve of the LD fluctuates depending on variation in a temperature, an extinction ratio varies sharply. Thus, it is difficult to completely compensate for the variations in the temperature.

### SUMMARY OF THE INVENTION

The present invention provides an apparatus for compensating for characteristics of a laser diode (LD) by varying a bias current of the LD depending on variations in a temperature so as to allow an output optical power of the LD to be constant and an optical transmitter including the apparatus.

According to an aspect of the present invention, there is provided an apparatus for compensating for characteristics of a laser diode so that the laser diode outputs an optical power at a constant level, the apparatus comprising: an optical output detector which detects an optical power output from the laser diode and converts the optical power into a voltage; a bias current controller which detects a maximum level of the voltage and outputs a first control value corresponding to a difference between the maximum level and a first reference voltage; a modulation current controller which detects a minimum level of the voltage and outputs a second control value corresponding to a difference between the minimum level and a second reference voltage; and a laser diode driver which outputs a drive current to the laser diode according to the first and second control values.

According to another aspect of the present invention, there is provided an optical transmitter for converting data to be transmitted into an optical signal and transmitting the optical signal, the optical transmitter comprising: a laser diode which outputs an optical signal according to a predetermined drive current; an optical output detector which detects an optical power output from the laser diode and converts the optical power into a voltage; a bias current controller which detects a maximum level of the voltage and outputs a first control value corresponding to a difference between the maximum level and a first reference voltage; a modulation current controller which detects a minimum level of the voltage and outputs a second control value corresponding to a difference between the minimum level and a second reference voltage; and a laser diode driver which receives the first and second control values as control signals and the data, generates currents according to the control signals and the data, and outputs the currents to the laser diode as the drive current.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of an apparatus for compensating for characteristics of a laser diode (LD) and an optical transmitter including the apparatus, according to the present invention;

FIGS. 2A and 2B are graphs showing general temperature characteristics of an LD; and

FIG. 3 illustrates a structure of an apparatus for compensating for characteristics of an LD and an optical transmitter including the apparatus, according to the prior art.

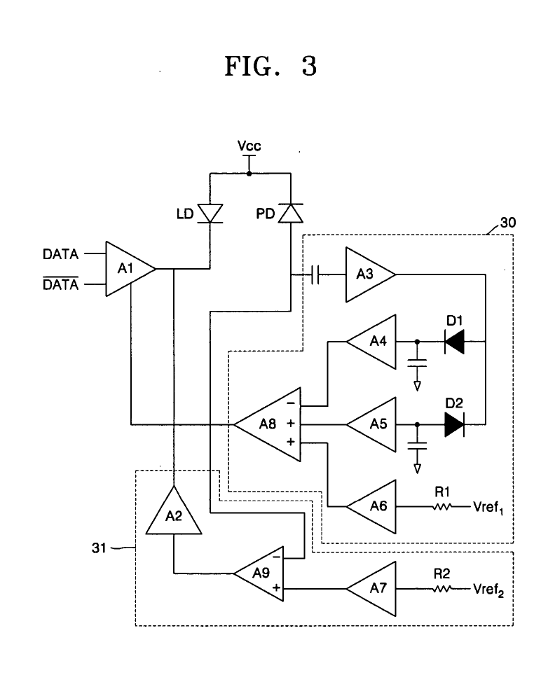

### DETAILED DESCRIPTION OF THE INVENTION

Hereinafter, the present invention will be described in detail with reference to the attached drawings.

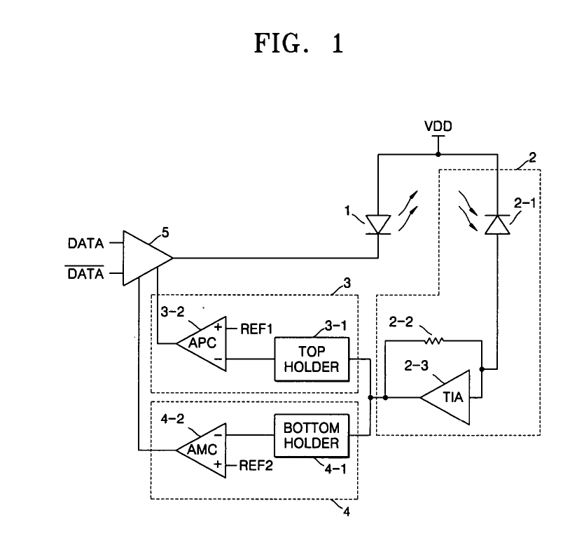

FIG. 1 illustrates a structure of an apparatus for compensating for characteristics of an LD and an optical transmitter including the apparatus, according to the present invention. Referring to FIG. 1, the apparatus includes an optical output detector 2, a bias current controller 3, and a modulation current controller 4. The optical transmitter includes an LD 1 which receives a drive current value controlled by the apparatus and an LD driver 5 which drives the LD 1 according to input data.

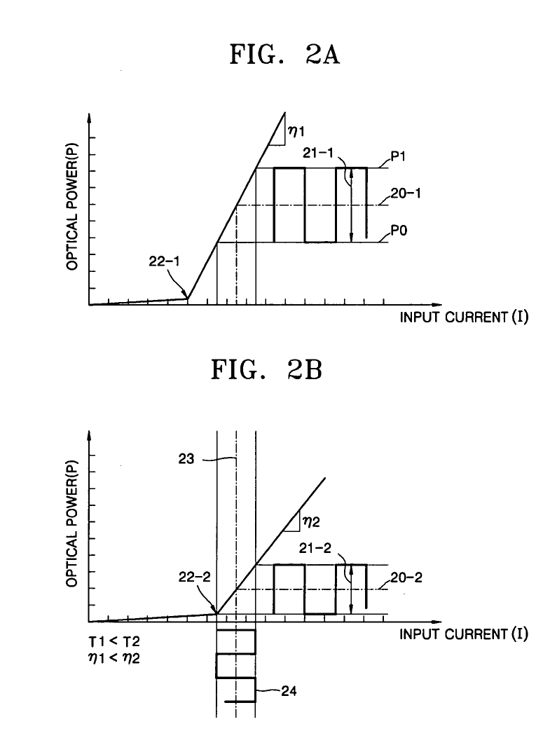

The optical output detector 2 includes a PD 2-1, a resister 2-2, and a transimpedance amplifier (TIA) 2-3 which is in parallel connected to the resister 2-2. The PD 2-1 detects an optical signal, which is output in the pulse form from the LD 1, and converts the optical signal into a current. The resister 2-2 and the TIA 2-3 convert the current into a voltage. For example, when the PD 2-1 detects a current level corresponding to the output power P₀ of FIG. 2, the resister 2-2 and the TIA 2-3 convert the current level into a maximum voltage level.

The bias current controller 3 includes a top holder 3-1 and an automatic power controller (APC) 3-2. The modulation current controller 4 includes a bottom holder 4-1 and an automatic modulation controller (AMC) 4-2. The top holder 3-1 and the bottom holder 4-1 detect maximum and minimum levels of a voltage, respectively, which is output in the pulse form from the TIA 2-3, hold the maximum and minimum levels for predetermined periods of time, and output the maximum and minimum levels. It is preferable that the APC 3-2 and the AMC 4-2 are operation amplifiers.

The APC 3-2 receives and compares a DC value corresponding to the maximum voltage level output from the top holder 3-1 and a first reference voltage REF1, amplifies a difference between the DC value and the first reference voltage REF1, and outputs the amplification result as a control value to the LD driver 5. The AMC 4-2 receives and compares a DC value corresponding to the minimum voltage level output from the bottom holder 4-2 and a second reference voltage REF2, amplifies a difference between the DC value and the second reference voltage REF2, and outputs the amplification result as a control value to the LD driver 5. The LD driver 5 outputs a drive current to the LD 1 according to data to be transmitted and the control values output from the bias current controller 3 and the modulation current controller 4. The LD 1 outputs an optical power at a constant level, whose its output power is adjusted according to the drive current. Here, the first and second reference voltages REF1 and REF2 are given externally.

A process of controlling the bias current in the above-described structure will now be described. When a temperature of the LD 1 increases, as shown in FIG. 2, the power level P₀ decreases. As a result, the voltage level detected by the top holder 3-1 becomes greater than the first reference voltage REF1. The APC 3-2 outputs the control value corresponding to a difference between input values, and the LD driver 5 increases the bias current by the control value. Thus, the optical power P₀ output from the LD 1 gets lift up. Accordingly, once reference voltages are set regardless of an employed LD, the power level P₀ can be prevented from dropping to a predetermined level due to a feedback.

According to the same principle, the AMC 4-2 outputs the same voltage as the second reference voltage REF2 so as not to drop the power level P₁ of the LD 1.

As described above, according to the present invention, an optical power at a constant level can be obtained regardless of the characteristics of an LD by externally setting reference voltages. As a result, a relatively stable transmission module for an optical communication can be realized at a low cost using a simple method.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for compensating for characteristics of a laser diode so that the laser diode outputs an optical power at a constant level, the apparatus comprising:
an optical output detector which detects an optical power output from the laser diode and converts the optical power into a voltage;
a bias current controller which detects a maximum level of the voltage and outputs a first control value corresponding to a difference between the maximum level and a first reference voltage;
a modulation current controller which detects a minimum level of the voltage and outputs a second control value corresponding to a difference between the minimum level and a second reference voltage; and
a laser diode driver which outputs a drive current to the laser diode according to the first and second control values.

2. The apparatus of claim 1, wherein the optical output detector comprises:
an optical/electric signal converter which converts the optical power output from the laser diode into a current;
a trans-impedance amplifier which inverts an output of the optical/electric signal converter; and
a resister which is in parallel connected to the trans-impedance amplifier and converts the current into a voltage.

3. The apparatus of claim 2, wherein the bias current controller comprises:
a top holder which detects the maximum level from voltage levels output from the optical output detector; and
an automatic power controller which compares an output of the top holder with the first reference voltage and outputs a control value corresponding to a difference between the output and the first reference voltage to the laser diode driver.

4. The apparatus of claim 2, wherein the modulation current controller comprises:
a bottom holder which detects the minimum level from voltage levels output from the optical output detector; and
an automatic modulation controller which compares an output of the bottom holder with the second reference voltage and outputs a difference between the output and the second reference voltage to the laser diode driver.

5. The apparatus of claim 1, wherein the modulation current controller comprises:
a bottom holder which detects the minimum level from voltage levels output from the optical output detector; and
an automatic modulation controller which compares an output of the bottom holder with the second reference voltage and outputs a difference between the output and the second reference voltage to the laser diode driver.

6. The apparatus of claim 1, wherein the bias current controller comprises:
a top holder which detects the maximum level from voltage levels output from the optical output detector; and
an automatic power controller which compares an output of the top holder with the first reference voltage and outputs a control value corresponding to a difference between the output and the first reference voltage to the laser diode driver.

7. An optical transmitter for converting data to be transmitted into an optical signal and transmitting the optical signal, the optical transmitter comprising:
a laser diode which outputs an optical signal according to a predetermined drive current;
an optical output detector which detects an optical power output from the laser diode and converts the optical power into a voltage;
a bias current controller which detects a maximum level of the voltage and outputs a first control value corresponding to a difference between the maximum level and a first reference voltage;
a modulation current controller which detects a minimum level of the voltage and outputs a second control value corresponding to a difference between the minimum level and a second reference voltage; and
a laser diode driver which receives the first and second control values as control signals and the data, generates currents according to the control signals and the data, and outputs the currents to the laser diode as the drive current.

8. The optical transmitter of claim 7, wherein the optical output detector comprises:
an optical/electric signal converter which converts the optical power output from the laser diode into a current;
a trans-impedance amplifier which inverts an output of the optical/electric signal converter; and
a resister which is in parallel connected to the trans-impedance amplifier and converts the current into a voltage.

9. The optical transmitter of claim 8, wherein the bias current controller comprises:
a top holder which detects the maximum level from voltage levels output from the optical output detector; and
an automatic power controller which compares an output of the top holder with the first reference voltage and outputs a control value corresponding to a difference between the output and the first reference voltage as the first control value to the laser diode driver.

10. The optical transmitter of claim 8, wherein the modulation current controller comprises:
a bottom holder which detects the minimum level from the voltage levels output from the optical power detector; and
an automatic modulation controller which compares an output of the bottom holder with the second reference voltage and outputs a difference between the output and the second reference voltage as the second control value to the laser diode driver.

11. The optical transmitter of claim 7, wherein the modulation current controller comprises:
a bottom holder which detects the minimum level from the voltage levels output from the optical power detector; and
an automatic modulation controller which compares an output of the bottom holder with the second reference voltage and outputs a difference between the output and the second reference voltage as the second control value to the laser diode driver.

12. The optical transmitter of claim 7, wherein the bias current controller comprises:
a top holder which detects the maximum level from voltage levels output from the optical output detector; and
an automatic power controller which compares an output of the top holder with the first reference voltage and outputs a control value corresponding to a difference between the output and the first reference voltage as the first control value to the laser diode driver.
